(19) United States
(12) Patent Application Publication
(10) Pub. No.: US 2026/0126132 A1
(43) Pub. Date: May 7, 2026

(54) Roller Equipped Pipe Support with Elastomeric Base

(71) Applicant: Clearline Technologies Ltd., Winnipeg (CA)

(72) Inventor: Neil Krovats, Winnipeg (CA)

(21) Appl. No.: 19/371,526

(22) Filed: Oct. 28, 2025

Related U.S. Application Data
(60) Provisional application No. 63/716,489, filed on Nov. 5, 2024.

(51) Int. Cl. F16L 3/01

(52) U.S. Cl. CPC F16L 3/01

(57) ABSTRACT

A novel pipe support features a block of elastomeric material, a roller cavity defined in the block and open at a topside thereof, and a roller rotatably supported on the block of elastomeric body in a position borne partially within the roller cavity thereof and rotatable about a laterally oriented rotation axis, and with an upper peripheral region of the roller elevated above the topside of the block for rested support of a pipe atop the upper peripheral region of the roller in a position lying axially of the block and transversely the rotation axis. A shaft of the roller is borne by the elastomeric material of the block, in shaft cavities or bores intersecting the left and right sides of the roller cavity. Identical blocks may be used in both roller-equipped and rollerless implementations of the pipe support.

### CROSS-REFERENCE TO RELATED APPLICATIONS

This application claims benefit under 35 U.S.C. 119(e) of U.S. Provisional Application No. 63/716,489, filed Nov. 5, 2024, the entirety of which is incorporated herein by reference.

### FIELD OF THE INVENTION

The present invention relates generally to pipe supports, and more particularly to pipe supports particularly useful for rooftop support of gas lines or other pipes on roofs of buildings.

### BACKGROUND

In the practice of supporting gas lines or other pipework on the roof of a building, there have been a variety of pipe support types proposed and commercialized within the prior art.

U.S. Pat. No. 6,682,025 discloses a pipe support embodied in a singular unitary body of rubber-like material with a hollow triangular base for sitting atop the roof, and a pair of curved flexible clamping arms standing upright from an upper apex of the triangular base in symmetrically disposed relation to one another with concave inner sides thereof facing together to create a pipe receiving cavity in which a pipe is receivable through gap between the upper tips of the clamping arms, particularly during a temporary widening of the gap via squeezing of the triangular base to spread the arms momentarily apart. A conceivable shortcoming of this design is a lack of accommodation for axial expansion and contraction of a pipe as a result temperature fluctuations experienced thereby in the environment of use.

In contrast, other pipe supports, such as those seen in U.S. Pat. Nos. 6,364,256 and 7,475,513, includes rollers to accommodate such axial pipe expansion and contraction. In these prior designs, a metal or plastic base is seated atop the roof, and a roller is rotatably supported on the base through some arrangement of mechanical couplers in a suitable position for receiving the pipe atop the roller in a position lying perpendicularly of the roller's rotational axis. A second upper roller or pipe strap is installed in an elevated position overhead of the roller to reside overtop the pipe for positive capture thereof in its roller-seated position. Threaded support shafts standing upright from the base allow are used for height adjustable support of the pipe supportive roller, pipe strap or upper roller. Examples of other roller-equipped pipe supports includes those available from C-Port, a division of Clearline Technologies Ltd. of Winnipeg, Manitoba, Canada, the present applicant, in their existing roller support product line.

While the foregoing roller-equipped pipe supports address the need to accommodate axial expansion and contraction or other axial movement of rooftop pipes, they do have drawbacks in terms of the notable part count in the pipe support assembly, and the amount of assembly and/or adjustment of componentry involved in the pipe installation process. Accordingly, there remains room for improvement in the field of roller-equipped rooftop pipe supports.

### SUMMARY OF THE INVENTION

According to a first aspect of the invention, there is provided a pipe support comprising:

a block of elastomeric material comprising an underside, a topside of opposing relationship to the underside in a height direction, a front side, a rear side of opposing relationship to the front side in an axial direction, a left side, and a right side of opposing relationship to the left side in a lateral direction;

a roller cavity defined in said block and that is open at the topside thereof and is bound by the elastomeric material of the block at least at left and right sides of the roller cavity that reside opposite of one another in the lateral direction; and

a roller rotatably supported on the block of elastomeric body in a position borne partially within the roller cavity thereof and rotatable about a laterally oriented rotation axis, and with an upper peripheral region of the roller elevated above the topside of the block for rested support of a pipe atop the upper peripheral region of the roller in a position lying axially of the block and transversely the rotation axis.

According to a second aspect of the invention, there is provided a method of producing roller-equipped and rollerless pipe supports, comprising producing or otherwise obtaining a plurality of elastomeric blocks having respective roller cavities therein of open character at topside of the elastomeric blocks, and installing rollers in the respective roller cavities of only a subset of said elastomeric blocks, for use of said subset of said elastomeric blocks in applications where axial pipe expansion and contraction is anticipated, and leaving another subset of said elastomeric blocks rollerless, for use of said another subset of the elastomeric blocks in applications where lesser, or no, axial pipe expansion and contraction is anticipated.

According to a third aspect of the invention, there is provided a pipe support comprising:

a unitary body of elastomeric composition comprising:
a base; and
first and second pliable arms integrally joined to said base and upstanding therefrom at positions spaced apart from one another in a lateral direction to form a pipe cavity between said first and second pliable arms in which a pipe can be laid across said base, in an axial direction transverse to said lateral direction, and laterally constrained between said pliable arms, which pliable arms terminate in respective terminal ends of non-attached relation to one another, at which terminal ends said pliable arms are spreadable apart, via resilient flexure of the pliable arms relative to the base, to increase a gap space between said terminal ends to permit admission of the pipe into said pipe cavity through said gap space; and

a roller cavity defined in said base of the unitary body in a position of open communication with said pipe cavity at a bottom thereof.

According to a fourth aspect of the invention, there is provided a method of producing a roller-equipped pipe support comprising producing or otherwise obtaining a pipe support according to the third aspect of the invention, and installing a roller in the roller cavity thereof by temporarily widening at least part of the roller cavity, inserting the roller into the temporarily widened roller cavity, and relaxing the roller cavity back to an unwidened state.

According to a fifth aspect of the invention, there is provided a method of installing a pipe support of the type recited in the third aspect of the invention, and further characterized by inclusion of first and second coupling apertures respectively provided in the first and second pliable arms, the method comprising engaging a coupler through said first and second apertures into a state holding the pliable arms of the pipe support together to limit or prevent spreading apart thereof.

### BRIEF DESCRIPTION OF THE DRAWINGS

Preferred embodiments of the invention will now be described in conjunction with the accompanying drawings in which:

FIG. 1 is a front left perspective view of a novel roller-equipped pipe support according to a first embodiment of the present invention.

FIG. 2 is a front right perspective view of the roller-equipped pipe support of FIG. 1.

FIG. 3 is a rear elevational view of the roller-equipped pipe support of FIG. 1, the front elevation view of which is identical.

FIG. 4 is a right side elevational view of the roller-equipped pipe support of FIG. 1, the left side elevational view of which is identical.

FIG. 5 is a cross-sectional view of the roller-equipped pipe support of FIG. 4, as taken along line B-B thereof.

FIG. 6 is a cross-sectional view of the roller-equipped pipe support of FIG. 3, as taken along line A-A thereof.

FIG. 7 is a front right perspective view of a main body of the roller-equipped pipe support of FIG. 1, in isolation, without a roller installed in a roller cavity thereof.

FIG. 8 is a cross-sectional view of the main body of FIG. 7, cross-sectioned in the same plane as FIG. 5.

FIG. 9 is a cross-sectional view of the main body of FIG. 7, cross-sectioned in the same plane as FIG. 6.

FIG. 10 schematically illustrates installation of a roller into the main body of FIG. 7 during assembly of the roller-equipped pipe support of FIG. 1.

FIG. 11 is a front right perspective view of a novel roller-equipped pipe support according to a second embodiment of the present invention.

FIG. 12 is a rear elevational view of the roller-equipped pipe support of FIG. 11.

FIG. 13 is a right side elevational view of the roller-equipped pipe support of FIG. 11.

FIG. 14 is a cross-sectional view of the roller-equipped pipe support of FIG. 13 as viewed along line C-C thereof.

FIG. 15 an exploded front right perspective view of the roller-equipped pipe support of FIG. 11.

FIGS. 16A to 16C illustrate sequential steps of installing the roller-equipped pipe support of FIG. 11 on a channel-equipped support block, and FIG. 16D is an enlarged fragmentary and cross-sectional view of the assembled roller-equipped pipe support and channel-equipped support block of FIG. 16C, as viewed along line D-D thereof.

FIG. 17 is an isolated perspective view of a flexible twist lock of the roller-equipped pipe support of FIG. 11 that is plugged into a base thereof for the purpose of engaging the base to a channel of the support block seen in FIGS. 16A-16D.

FIG. 18 is a front left perspective view of a roller-equipped pipe support according to a third embodiment of the present invention.

FIG. 19 is a rear left perspective view of the roller-equipped pipe support of FIG. 18.

FIG. 20 is a rear elevational view of the roller-equipped pipe support of FIG. 18.

FIG. 21 is a side elevational view of the roller-equipped pipe support of FIG. 18, of which the opposing side view is identical.

FIG. 22 is a front elevational view of the roller-equipped pipe support of FIG. 18.

FIG. 23 is a top plan view of the roller-equipped pipe support of FIG. 18.

FIG. 24 is a front right perspective view of a variant of the second embodiment roller-equipped pipe support.

FIG. 25 is a left side elevational view of the roller-equipped pipe support of FIG. 24.

FIG. 26 is a cross-sectional view of the roller-equipped pipe support of FIG. 25 as viewed along line E-E thereof.

### DETAILED DESCRIPTION

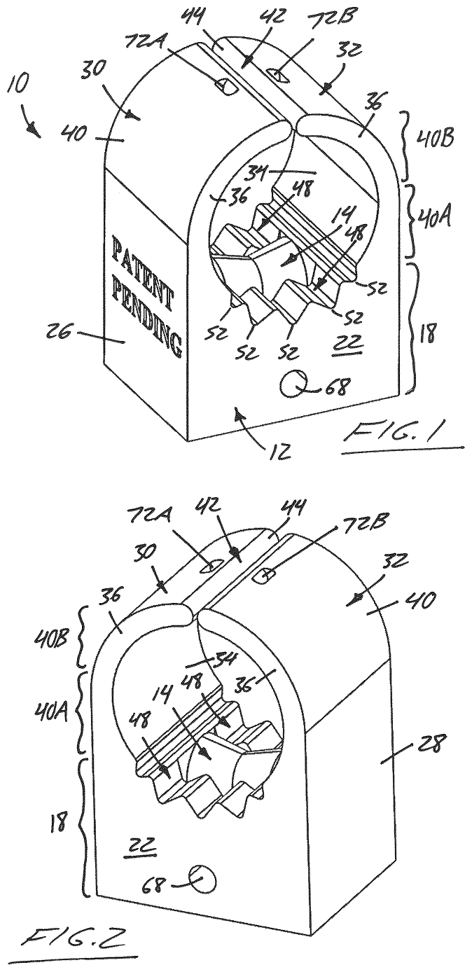

FIGS. 1 through 6 illustrated a roller-equipped pipe support 10 according to one preferred embodiment of the present invention, which is particularly characterized by uniquely low part count in its construction, denoting an improvement in the manufacturing simplicity and efficiency of the product, as well as a likewise beneficial simplicity and efficiency in the product's installation in a pipe supporting environment, typically a rooftop environment, though the product is not necessarily limited to rooftop applications. The pipe support 10, at least in the first illustrated embodiment, consists solely of a unitary main body 12, a roller 14 and a roller shaft 16 on which said roller 14 is rotatable, of which the main body 12 directly supports the roller shaft 16, without need for separate mechanical fastening or holding means for attaching said roller shaft to the main body 12. The design of the main body 12 also enables optional use thereof without an accompanying roller 14 and roller shaft 16, for example for use in environments where zero or minimal axial expansion, contraction or shifting is expected of the pipe being supported, for example in relatively temperature stable environments where thermal expansion and contraction of the pipe is nonexistent or negligible. Therefore, the same main body 12 can be sold in roller-equipped and rollerless forms, yet manufactured identically for both applications, denoting an optimal manufacturing efficiency.

The main body 12 is a molded unitary body of an elastomeric composition to allow flexure thereof, of one type during assembly of the main body 12 with the roller 14 and roller shaft 16 for roller-equipped pipe support applications, and of another type during installation of the pipe support 10 into any pipe supporting application, whether roller-equipped or rollerless. More detail on these assembly and installation processes, and the associated flexure types that the main body 12 is subjected to during said processes, will follow, further below.

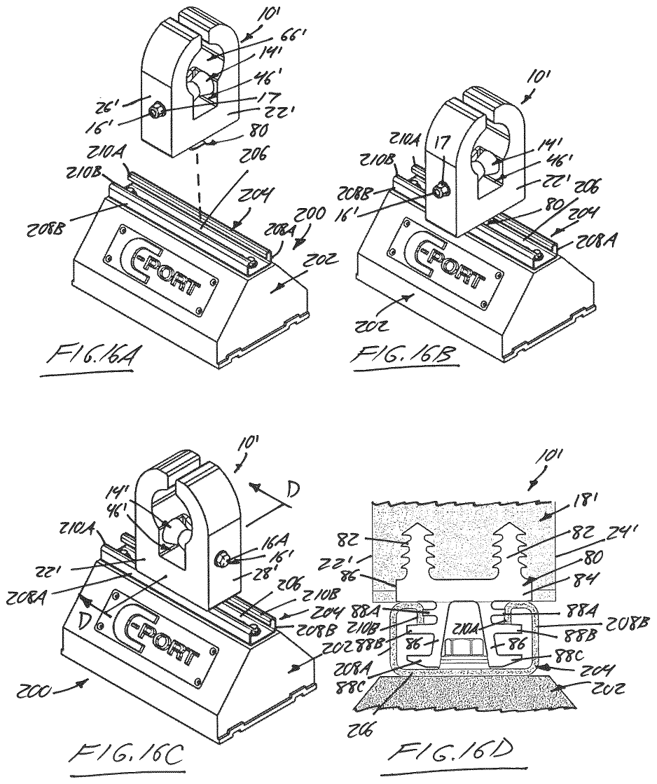

The main body 12 is characterized as having a block-like base 18, which in the first embodiment, has a flat underside 20 for seating flat atop a roof or other surface, at least in some installation types, though the same flat-bottomed pipe support 10 may optionally be used in other installations types involving indirect mounting of the pipe support 10 on the roof through one or more intermediary pieces of mounting equipment, as described of other embodiments further below with reference to FIGS. 16A-16D. An exterior of the base 18 has a front face 22, an opposing rear face 24, a left side 26, and a right side 28. A directionality in which the front and rear faces are spaced apart is referred to herein as an axial direction, as it is in this direction that the axis of a supported pipe will run when supported by the pipe support 10. A directionality that is orthogonal to the axial direction, and in which the two sides 26, 28 of the body 12 are spaced apart, is referred to herein as a lateral direction. The axial and lateral directions may be referred to herein as horizontal directions, referring to occupancy a horizontal plane by each thereof in a scenario where the flat underside of the base 20 is seated atop a horizontal surface, solely in the interest of defining a reference frame in which to describing geometric relationships between various features of the pipe support. A vertical height direction thus refers to a third and final one of three orthogonally related directionalities of the reference frame, relative to which the terms top, bottom, upper, lower and height may be used herein to describe such relationships.

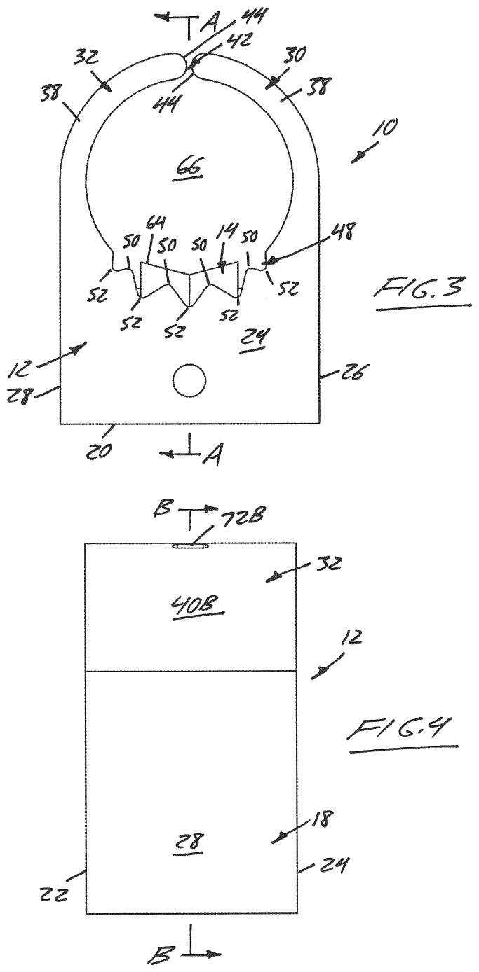

In addition to the base 18, a remainder of the main body 12 is constituted by a pair of pliable arms 30, 32 that are integrally and seamlessly joined to the base 18, and reside in upstanding relationship to the base 18 at laterally spaced apart positions thereon, such that each pliable arm 30, 32 resides nearer to a respective one of the base's outer sides 26, 28 than the other pliable arm. The two pliable arms 30, 32 are of symmetric relationship to one another across a vertical axial midplane, which is denoted by cross-sectional line A-A of FIG. 3. Each pliable arm 30, 32 is characterized by a concave inner side 34 that faces toward the other arm's matching concave inner side 34, and shares the same radius of curvature and same radial center therewith. Accordingly, the concave inner sides 34 of the two pliable arms 30, 32 occupy respective arcuate segments of an imaginary reference circle (not shown) that is likewise centered on the shared radial center of the concave inner sides 34 of the two pliable arms 30, 32.

In the illustrated example, each pliable arm 30, 32 has an axial width equal to that of the base 18, whereby a front edge 36 of each pliable arm 30, 32 is coplanar with the front face 22 of the base 18, and a rear edge 38 of each pliable arm 30, 32 is likewise coplanar with the rear face 24 of the base 18, though this need not necessarily be the case in other embodiments. In the first illustrated embodiment, the outer sides 26, 28 of the base 18 reside parallel to one another in respective vertical planes parallel to the vertical axial midplane A-A, and an outer side 40 of each pliable arm 30, 32, at a lower region 40A thereof, is a coplanar extension of the respective outer side of the base 26, 28. An upper region 40B of the outer side 40 of each pliable arm 30, 32 deviates from the lower region's coplanar relationship to the respective side of the base 18, instead having a convex curvature that curves upwardly and inwardly toward the vertical axial midplane A-A. In the illustrated example, the convex upper region 40B of the outer side 40 of each pliable arm 26, 28 shares the same radial center as the concave inner sides 34 of the two pliable arms 30, 32, whereby each pliable arm 30, 32 has a uniform lateral thickness throughout this upper region 40B, though again this need not necessarily be the case in all embodiments. Each pliable arm 30, 32, in its upward reach from the base 18 and its laterally inward reach toward the vertical axial midplane A-A, stops short of the vertical axial midplane, whereby a central gap 42 is left void between the two pliable arms 30, 32 at the vertical axial midplane that denotes the lateral center of the pipe support 10. The extremities of the two pliable arms on opposing sides of the vertical axial midplane are referred to herein as terminal ends 44 of the pliable arms 30, 32, which terminal ends are of unattached relationship to one another across the void central gap 42 left therebetween. In a variant of this design, the terminal ends 44 of the pliable arms 30, 32 may touch one another at the vertical axial midplane A-A, so long as they are still of unattached relationship to one another.

A topside of the base 18, at a laterally central region thereof unoccupied by the integrally attached lower regions of the two pliable arms 30, 32 is characterized by inclusion therein of a roller cavity 46 that occupies a partial axial width of the topside of the base 18. At each one of two areas axially neighbouring the roller cavity 46 on axially opposing sides thereof, the topside of the base 18 in this illustrated example is characterized by a serrated shape profile 48 possessing peaks 50 and valleys 52 of alternating relationship to one another in a circumferential direction around the radial center of the inner concavities of the two pliable arms 30, 32. Each serrated profile 48 has an axial width that spans fully from the roller cavity 46 to the respective front or rear face 22, 24 of the base 18, whereby each peak 50 and valley 52 runs axially from the roller cavity 46 to the respective front or rear face 22, 24 of the base 18. In the illustrated example, each peak 50 of the serrated shape profile 48 lies on or near the same imaginary circle as the concave inner sides of the two pliable arms 30, 32.

The roller cavity 46 is bound in the axial direction by a front wall 54 nearest to the front face 22 of the base 18, and an opposing rear wall 56 nearest to the rear face 24 of the base 18. In the lateral direction, the roller cavity is bound by left and right sidewalls 58, 60 residing respectively nearest the left and right outer sides 26, 28 of the base. The roller cavity 46 is laterally centered on the base, so that the roller cavity's lateral sidewalls 58, 60 are equidistant from their respective outer sides 26, 28 of the base, and are symmetric to one another across the vertical axial midplane A-A. In the illustrated example, the roller cavity 46 is also axially centered on the base 18, so that the front and rear walls 54, 56 of the roller cavity 46 are equidistant from their respective front and rear faces of the base 18, whereby the two serrated shape profiles 48 are accordingly equal to one another in axial thickness. Each sidewall 58, 60 of the roller cavity has a recessed shaft cavity 62 therein of round cylindrical profile for receiving a respective end of the roller shaft 16 to enable support of the roller shaft 16 in a position spanning laterally across the roller cavity 46 at an upper elevation thereof below the imaginary circle shared by the serration peaks and the concave inner sides of the pliable arms 30, 32. The two shaft cavities 62 are of matching size and shape and reside at matching heights on the two sidewalls of the roller cavity.

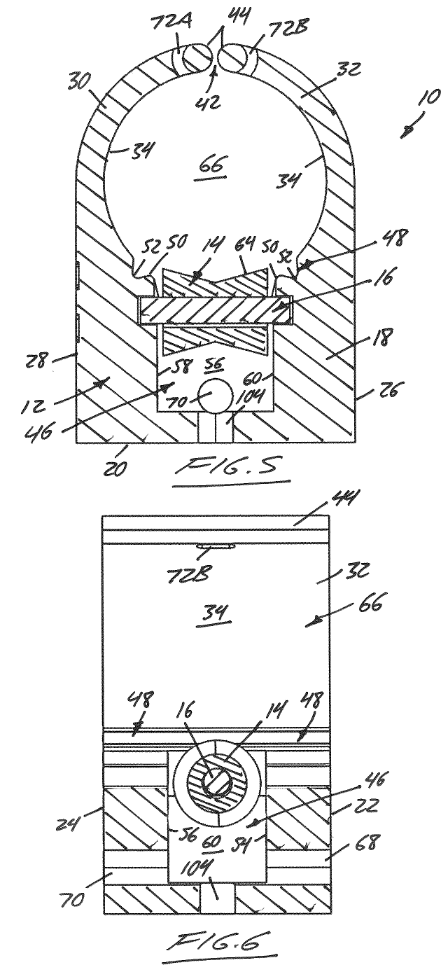

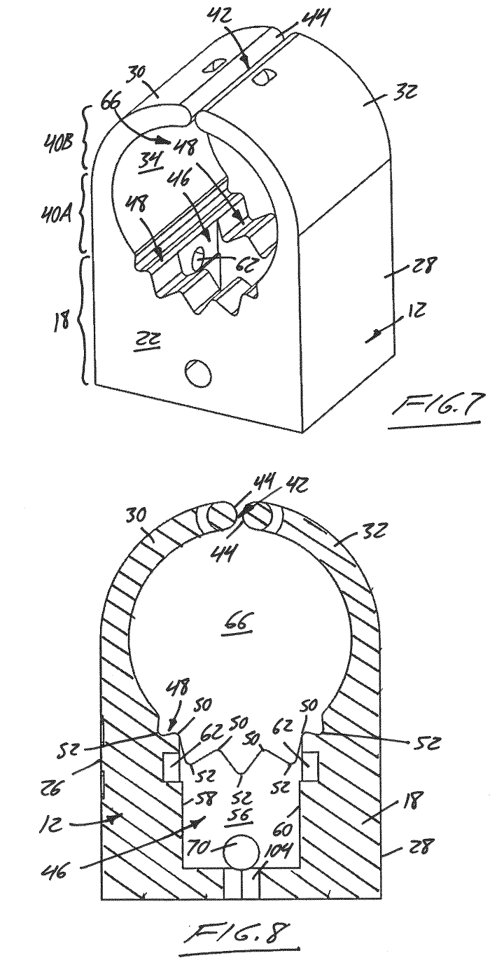

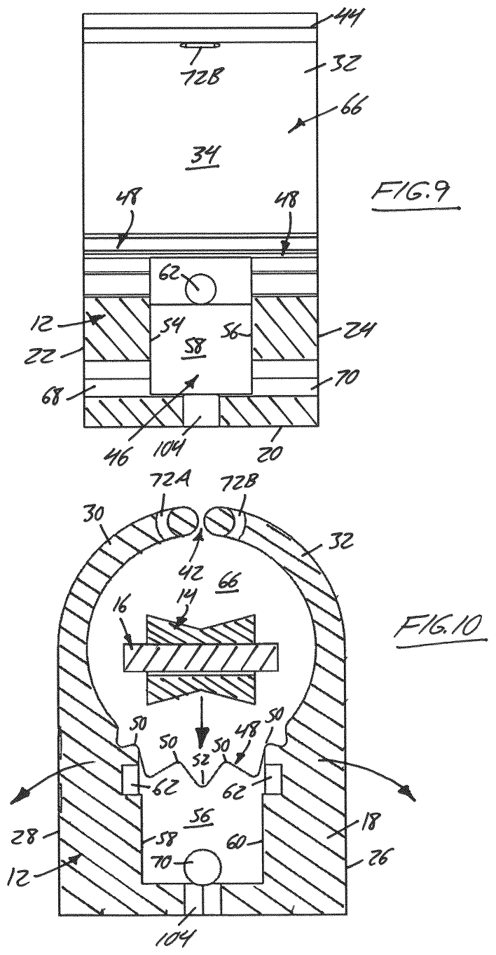

The roller 14 is journaled on the roller shaft 16 for rotation about a central axis thereof. The roller 14 is a tapered roller, whose radial measure relative to the central axis of the roller shaft 16 is at a minimum at a midpoint of the roller's length (as measured along the roller shaft 14), and increases in both directions moving outward form this lengthwise midpoint of the roller 14 to the roller's two opposing ends. The length of the roller 14 is slightly less than the lateral width of the roller cavity 46, as measured between the two sidewalls 58, 60 thereof, while the length of the roller shaft 16 exceeds the lateral width of the roller cavity 46 to enable the support of the roller shaft's two opposing ends in the two aligned shaft cavities 62. The cross-sectional view of FIG. 5 particularly reveals the installed position of the assembled roller 14 and roller shaft 16 (or roller assembly, for short), where the roller shaft 16 spans laterally across the roller cavity 46 near an open top end thereof, just beneath the imaginary reference circle, while an uppermost peripheral region 64 of the roller 14 resides just above the imaginary reference circle.

The space bound between the concave inner sides 34 of the two pliable arms 30, 32 above the preferably serrated topside of the base 18 and below the gap-spaced terminal ends 44 of the two pliable arms 30, 32 denotes a generally round pipe cavity 66 in which a pipe can be received in a position laying axially across the topside of the base 18 in rested placement on the roller 14. The pipe rests at the roller's uppermost peripheral region 64 that resides slightly above the base 18 in exposed relation to the pipe cavity 66 within a lower region thereof closely adjacent the base 18. Insertion of the pipe into the pipe cavity 66 in a direction of radial relation to both thereof is accommodated by temporary resilient flexure of the pliable arms 30, 32 relative to the base 18 in laterally outward directions away from one another to enlarge the gap space 42 between the terminal ends 44 of the pliable arms 30, 32 to a size at least equal to, if not exceeding, the outer diameter of the pipe. With the terminal ends 44 of the pliable arms 30, 32 temporarily spread apart in such fashion, the pipe is inserted radially into the pipe cavity 66, whereafter the pliable arms 30, 32 are released from their flexed state, and resiliently relax back to their default unflexed positions in which their terminal ends 44 reside closely adjacent to one another and the vertical-axial midplane A-A, thereby denoting reduction of the gap 42 back to its default narrow state. In this relaxed state, the two pliable arms 30, 32 stand upright on opposite sides of the pipe to constrain the pipe from being dislodged laterally off the roller 14, and also arch inwardly over the top quadrants of the pipe in furtherance of the captured state thereof in the pipe cavity 66. The two ends of the roller shaft 16 are supported within the two shaft cavities 62 solely by circumferential encapsulation of each shaft end by the constituent material of the main body 12. The roller 14, being rotatable about the supported roller shaft 16, accommodates axial expansion and contraction, or other axial movement, of the pipe within the pipe cavity 66. Support of the roller shaft 14 in encapsulated fashion within the shaft cavities 62 of the main body 12 omits the need for additional shaft mounting hardware, denoting a beneficially efficient design in terms of both the part count of the pipe support, and the ease of assembly thereof.

On the other hand, for installations where axial pipe expansion and contraction is not anticipated, the same main body design capable of this fastener-free support of a shaft roller 16 in operably exposed relation to the pipe cavity 66 can optionally be used in isolated fashion without a roller 14 and corresponding roller shaft 16. A manufacturer can thus produce a plurality of identical main bodies 12, and among said plurality of main bodies 12, install respective rollers 14 and associated roller shafts 16 in only of subset of those plurality of main bodies 12, thereby producing a first quantity of roller-equipped pipe supports for installations in applications or environments where axial expansion and contraction of pipes is anticipated. Meanwhile, another subset of the plurality of identical main bodies 12 can be left void of respective rollers and roller shafts, thereby producing a second quantity of rollerless pipe supports for installations in applications or environments where accommodation of axial expansion and contraction of pipes is not necessary. In the latter instance of a rollerless pipe support, the pipe is admitted into the pipe cavity 66 of the rollerless pipe support in the same manner described above, during temporary flexure of the pliable arms 30, 32 laterally away from one another, but is seated directly on the topside of the base 18, rather than on a roller 14, such that the pipe rests upon the peaks 50 of the two serrated regions 48 of the base 18 on axially opposing sides of the unoccupied roller cavity 46 of the rollerless pipe support. The valleys 52 between the pipe supporting peaks 50 allow for drainage of rainwater from beneath the support pipe, though the serrated profile of the base's topside may optionally be omitted in other embodiments.

To prevent rainwater accumulation within the roller cavity 46, one or more drain ports are included to permit drainage of rainwater from the roller cavity 46 to the surrounding environment located externally of the main body 12. In the illustrated example, the drain ports comprise two axial drain ports, namely a front axial drain port 68 that penetrates the front wall 54 of the roller cavity 46 through to the front face 22 of the main body 12, and a rear axial drain port 70 that penetrates the rear wall 56 of the roller cavity 46 through to the rear face 24 of the main body 12. Other embodiments may additionally or alternatively feature left and right lateral drain ports, each penetrating a respective left or right sidewall 58, 60 of the roller cavity 46 through to the respective left or right outer side 26, 28 of the main body 12. Such pairing drain ports in one or more directionally opposing pairs (paired front and rear axial drain ports, and/or paired left and right lateral drain ports) ensures that drainage can occur in either of the two axially opposing or laterally opposing directions, as the drainage direction may vary according to the level or sloped nature of the roof or surface on which the base 18 is seated or otherwise supported. These drain ports preferably reside at a relatively low elevation of the roller cavity shared by a bottom wall thereof to ensure drainage without any pooling of rainwater atop the bottom wall of the roller cavity.

Installation of the roller 14 and roller shaft 16 into the main body 12 in the instance of a roller-equipped pipe supports is typically, though not necessarily always, expected to be performed in a production or distribution environment as opposed to assembly by the customer or installer at the intended site of installation. Such installation, in the case of the first illustrated embodiment, involves forced flexure of the base 18 at the topside thereof in a laterally outward manner deflecting at least one of the two lateral sidewalls 58, 60 of the roller cavity 46 away from the other one of those lateral sidewalls, particularly at the upper elevation of the roller cavity 46 occupied by the shaft cavities 62 near the open top of the roller cavity. This temporarily increases the lateral width of the roller cavity 46 at the open top and upper elevation thereof to a distance allowing insertion of the ends of the roller shaft 16 into the shaft cavities 62, whether this be both ends at once, if enabled by sufficient temporary widening of the roller cavity's top end and upper elevation, or one end at a time. The temporary widening of the roller cavity may be caused or aided by forced insertion of the roller shaft 16, for example forcing a first end thereof into a first one of the shaft cavities 62 and thereafter forcibly lowering the second end of the roller shaft 16 down through the open top of the roller cavity 46 to stretch the lateral width thereof until this second end of the roller shaft 16 slips into the second roller cavity 62, where after the roller cavity's top end and upper elevation will both relax back to their default unstretched width.

Alternatively, the temporary widening of the roller cavity 46 and holding of this widened state during insertion of the roller-equipped roller shaft 16 may be performed through direct manual flexure of the main body 12 in a human performed or human aided assembly process, or via machine performed flexure of the main body 12 in an automated or semi-automated assembly process. Regardless of the employed mode of cavity widening, relaxation of the temporarily widened roller cavity 46 back to its default unwidened state will positively capture each of the two ends of the roller shaft 16 within the respective one of the two shaft cavities 62, inside of which a full 360-degree circumference of the respective end of the roller shaft is surrounded by a full by the constituent material of the main body 12. This assembly methodology achieves reliable securement of the roller shaft 16 to the main body 12 without the use of any mechanical fasteners.

As to the capture of the pipe within the pipe cavity 66, the robustness of this capture may optionally be improved over pure reliance of the resilient character of the pliable arms 30, 32 alone, for example by installing an optional coupler between the pliable arms to span across or close the gap 42 between the terminal ends 44 of the pliable arms 30, 32 in a manner securing the two arms together at this apex point above the pipe. For such purpose, the first illustrated embodiment features a respective coupling aperture 72A, 72B in each of the two pliable arms 30, 32 near the terminal end 44 thereof so that a zip tie, or other closeable coupler, can be fed through the two coupling apertures 72A, 72B and secured into a closed loop holding the two pliable arms together. Such coupling together of the two pliable arms at or near their terminal ends 44 serves to limit or prevent unintentional spreading apart thereof, which serves to prevent possible escape of the pipe through the gap 42 if unintentionally widened by unintended outward flexure of the pliable arms 30, 32.

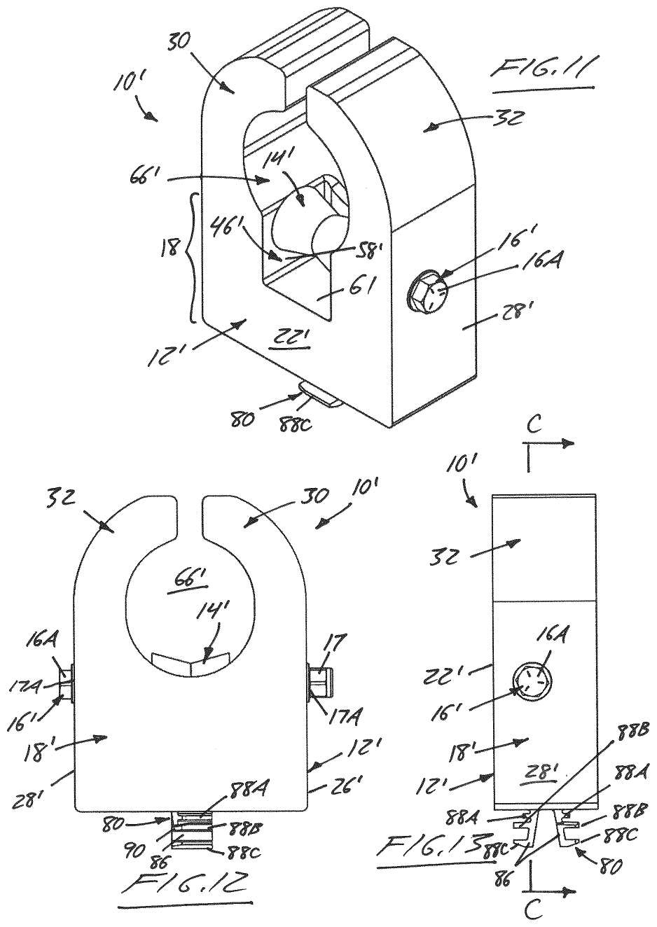

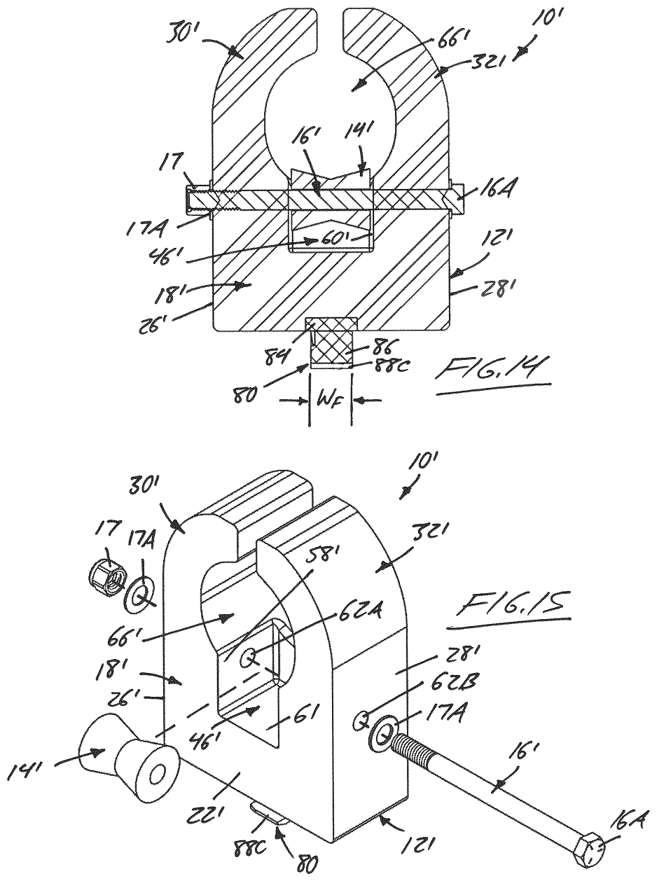

FIGS. 11 to 15 illustrate a second embodiment of the roller-equipped pipe support 10′, description of which is made primarily in terms of features that differentiate it from the preceding embodiment, in the interest of brevity, in view of which any undescribed features of this second embodiment may be identical to those of preceding embodiment, in at least some implementations of this alternative embodiment. The main body 12′ is again a molded unitary body of an elastomeric composition, and characterized as having a block-like base 18′ and a symmetric pair of pliable arms 30′, 32′ standing upward therefrom to delimit a generally round pipe cavity 66′ between the concave inner sides of the two pliable arms 30′, 32′. A roller cavity 46′ is again recessed into the base 18′ at the topside thereof and between the two pliable arms 30, 32′ to again host a tapered roller 14′ rotatably journaled on a roller shaft 16′ that again spans laterally across the roller cavity 46′ to host the tapered roller 14′ in a position placing its uppermost peripheral region 64 resides slightly above the base 18 in exposed relation to the pipe cavity 66 and just above the imaginary reference circle on which the concave sides of the pliable arms are arched, and beneath which the roller shaft 16′ resides. The illustrated example of this embodiment lacks a serrated shape profile at the topside of the base, but may alternatively incorporate such serrated shape profile in other implementations of this embodiment.

This embodiment of the roller-equipped pipe support 10′ differs in the configuration of its roller cavity 46′ and its roller shaft 16′, in that the roller cavity is of open character at the front face 22′ of the base 18′ instead of having a closed front cavity wall thereat. In another differentiation, instead of having a recessed shaft cavity 62 in each sidewall 58, 60 of the roller cavity 46′, each roller cavity sidewall 58′, 60′ of the roller cavity 46′ is instead intersected by a respective shaft bore 62A, 62B that penetrates into the roller cavity 46′ from a respective one of the left and right outer sides 26′, 28′ of the base 18′. That is, the left cavity sidewall 58 is penetrated by a left shaft bore 62A that also penetrates the left outer side 26′ of the base 18′, and the right cavity sidewall 60 is penetrated by a right shaft bore 62B that also penetrates the right outer side 28′ of the base 18′. The two shaft bores 62A, 62B axially align with one another across the roller cavity 46′, and the roller shaft 16′ of this embodiment spans axially and fully through both of the two shaft bores 62A, 62B so that the two ultimate ends of the roller shaft 16′ reside externally of the base 18′ at the opposing left and right outer sides 26′, 28′ thereof. The roller shaft 16′ of this embodiment is bolt whose enlarged head 16A resides outside the base 18′ at one side thereof, and whose threaded end resides outside the base 18′ at the opposing side thereof, and is engaged by a cooperatively threaded nut 17. The portion of the bolt shaft that resides within the roller cavity is a smooth-walled (unthreaded) section of the bolt shaft, on which the roller 14′ can smoothly rotate in absence of any crested threads of the bolt that might otherwise frictionally bite the inside of the roller 14′ and hinder rotation thereof.

In assembly of this embodiment of the roller-equipped pipe support 10′, the roller 14′ alone is first inserted into the roller cavity 46′, for example through the open front of this illustrated example of the modified roller cavity 46′. The inserted roller 14′ is held in a position aligning the internal through-bore of the roller 14′ with the two shaft bores 62A, 62B of the base 18′, and the threaded end of the roller shaft 16′ is then inserted through a first one of the shaft bores 62A, 62B from one side of the base 18′, onward through the internal through-bore of the roller 14′, and ultimately onward through the second of the shaft bores 62A, 62B to the opposing side of the base 18′. Here, externally of the base 18′, the nut 17 is then threaded onto the roller shaft at the threaded end thereof, thus completing the installation of the roller 14′ and its associated roller shaft 16′ in the roller cavity 46′. The head 16A of the roller shaft 16′ and the nut 17 are typically accompanied by respective washers 17A. This embodiment may be easier to assemble, avoiding the preceding embodiment's need to temporarily widen the roller cavity 46 through flexure of the base 18′ of the main body 12′ body to accommodate insertion of the roller shaft into recessed shaft cavities in the sidewalls of the roller cavity.

The open-fronted character of the illustrated roller cavity 46′ of the second embodiment also eases the insertion of the roller 14 into the roller cavity during assembly, rather than having to do so via the pipe cavity 66′ in the case of a roller cavity that is instead only open at the top, though such top loading of the roller could also be performed in this embodiment, whether or not the roller cavity is also open at the front. That said, another benefit of having the roller cavity open at its front side, especially when open all the way down to the floor of the roller cavity, is that this open front of the roller cavity 26′ enables draining of rainwater therefrom, in alternative to the front axial drain port 68 of the preceding embodiment. Though a fully open front of the roller cavity may fulfill all drainage needs, such front drainage may optionally be supplemented by inclusion of one or more such drain ports in any one or more of the three sidewalls of the open-fronted roller cavity of this embodiment. The floor surface of the roller cavity 46, embodied by the topside of the roller cavity's bottom wall 61, may optionally be sloped downwardly toward the open front of the roller cavity 26′ to further encourage draining thereof.

The present embodiment is further differentiated from the preceding one by inclusion of a twist lock 80 that protrudes from the underside 20′ of the base 18′ for the purpose of mating engagement of the base 18′ with a channel-equipped support block assembly 200, an example of which is shown in combination with the roller-equipped pipe support 10′ in FIGS. 16A through 16D. The support block assembly 200 is composed of a molded elastomeric support block 202 atop which there is affixed a length of rigid (e.g. galvanized steel) channel 204 running in a longitudinal direction of an elongated flat top wall of the support block 206, from which a pair of sloped side walls diverge downwardly from opposing sides of the flat top wall to impart a downward widening of a cross-sectional shape profile of the support block 202, whose flat bottom lies opposite and parallel to the flat top wall for seated resting of the support block 202 on a rooftop or other surface. The downwardly widening shape profile of the support block, in cross-sectional planes lying normal to the longitudinal direction thereof, makes for a wider character thereof at the flat bottom than at the top wall, for optimal stability of the support block in its seated position on the rooftop or other underlying surface. For more details of the support block assembly 200, reference may be made to Applicant's U.S. Pat. No. 9,315,990, the entirety of which is incorporated herein by reference.

The channel 204 is an open-topped channel having a bottom wall 206 seated flat atop the top wall of the support block 202, and a pair of sidewalls 208A, 208B standing upright from the bottom wall 206 and running along the opposing sides of the support block's top wall. Via the open internal space of the channel 204 between the sidewalls 208A, 208B thereof, the bottom wall 206 of the channel 204 is bolted to the underlying support block 202 in flush relationship against the flat top wall thereof. Each sidewall 208A, 208B of the channel terminates in a downturned inside lip 210A, 210B running along the inside of the sidewall at an elevated height above the bottom wall 206 of the channel 204.

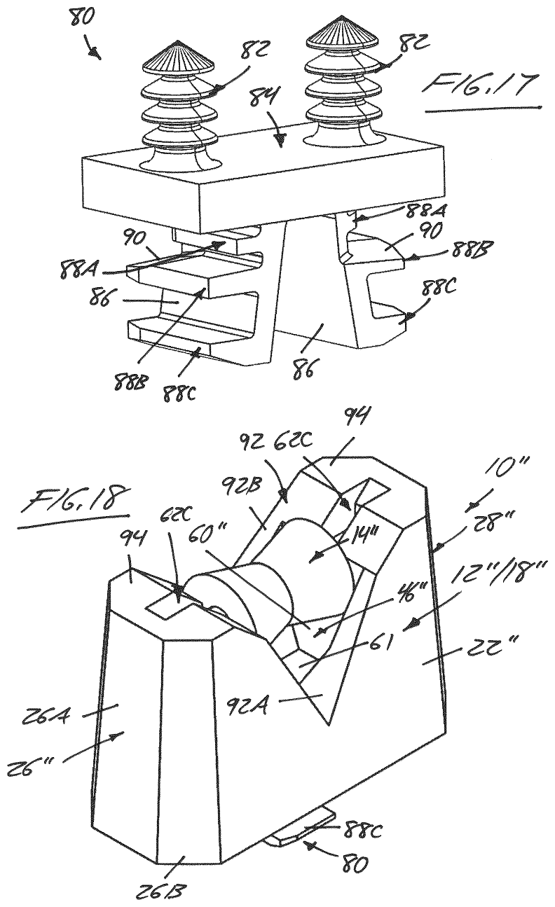

The twist lock 80 is shown at enlarged scale in isolation from the rest of the roller-equipped pipe support 10′ in FIG. 17. In the illustrated example, the twist lock 80 is embodied as a plug-in attachment selectively attachable to the base 18′ of the pipe support 10′ at the underside 20′ thereof by engagement of a pair of barbed plugs 82 of the twist lock 80 into an equivalently spaced pair of predefined receiving sockets recessed into the base 18′ of the pipe support 10′ at the underside 20′ of said base 18′. The twist lock is composed of a flexible polymeric material, which may be the same elastomeric material from which the main body 12″ of the pipe support 10″ is composed, though this need not necessarily be the case in all implementations of the twist lock. The barbed plugs 82 stand proud from an otherwise flat head 84 of the twist lock 80, for which head 84 there is a matably shaped host cavity 86 recessed into the underside 20 of the base 18′, from which host cavity 86 the receiving sockets for the barbed plugs 82 are recessed further upwardly into the base 18′ from the underside 20′ thereof. The head 84 of the twist lock 80 and the host cavity 86 of the base 18′ are of elongated rectangular shape in the illustrated example, whereby the head 84 and host cavity 86 must be oriented in aligned relationship to one another for mating receipt of the head in the host cavity, in which state the underside of the head 84′ sits flush with neighbouring areas of the underside of the base 18′. Making the matability of the head and the host cavity conditional on a geometric alignment of the two ensures that the plug-in twist lock 80 is installed in a proper working orientation on the base 18′ of the pipe support 10′ that corresponds to a predetermined working orientation of the base 18′ of the pipe support 10′ on the support block assembly 200. In the illustrated example, this working orientation of the pipe support 10′ is one in which the axis of the pipe cavity 66′, along which the supported pipe will ultimately run, lies perpendicular to the longitudinal direction in which the channel 204 of the support block assembly 200 runs.

Protruding downwardly from the head 84 are two legs 86 of the twist lock 80, which in the illustrated embodiment are of downwardly divergent relationship to one another. Each leg 86 features a plurality of retaining fins projecting outwardly therefrom in a directionality away from the other leg. There are three such retaining fins 88A, 88B, 88C on each leg in the illustrated example: an upper fin 88A, an intermediate fin 88B and a lower fin 88C, which are of descending elevation on the leg 86 in this order. The upper fin 88A is a shortest of the three, for frictional engagement with inside faces of the two inside lips 210A, 210B of the channel 204 in the installed state of the pipe support 10′ on the support block assembly 200, as revealed in the cross-sectional view of FIG. 16D. The intermediate fins 88B protrude further outward from the two legs 86 to hook underneath the downwardly pointing tips of the two inside lips 210A, 210B of the channel 204 in the installed state of the pipe support 10′ on the support block assembly 200, as also revealed in the cross-sectional view of FIG. 16D. The lower fins 88C reside at the lowermost extremes of the legs 86 for frictional engagement against the bottom wall 206 of the channel 204 in the installed state of the pipe support 10′ on the support block assembly 200, as also revealed in the cross-sectional view of FIG. 16D. The engagement of the lower fins 88C with the bottom wall 206 of the channel 204 helps stabilize the twist lock 80 and the attached base 18′ of the pipe support 10′, whose underside 20′ rests atop the channel 204 in this installed state of the pipe support 10′, in which the hooked engagement of the intermediate fins 88B of the twist lock 80 beneath the inside lips 210A, 210B of the channel 204 prevents lifting of the installed pipe support 10′ from the support base assembly 200. The lower fins 88C also serve to provide a more easily grippable interface by which the twist lock 80 can be held during plugged engagement thereof to the base 18′ of the pipe support 10′ at the underside 20′ thereof.

The fins 88A-88C on one leg of the twist lock 80 point toward the plane of the front face 22′ of the main body 12′ of the pipe support 10′, and the fins on the other leg of the twist lock 80 point oppositely toward the plane of the opposing rear face 24′ of the main body 12′ of the pipe support 10′. The two intermediate fins 88B are tapered in thickness at tapered end regions 90 thereof situated adjacent diagonally opposite ends of these two fins 88B. The tapered end region 90 of each intermediate fin 88B tapers in thickness toward that respective end of the fin. Referring to FIG. 16A, to install the pipe support 10′ on the support block assembly 200, first the pipe support 10′ is placed in elevated relationship above the support block assembly 200 and oriented with its front and rear faces 22′, 24′ facing longitudinally of the support block assembly 200, so that the fins 88A-88C of the twist lock likewise point in the longitudinal directionality of the support block assembly.

The width W_{F} of each fin 88A-88C and associated leg 86, measured perpendicularly of the direction in which the fin points outwardly from the respective leg 86, is slightly less than the distance between the two inside lips 210A, 210B of the channel 204, and so in the installation-ready orientation of the pipe support 10′ in FIG. 16A, the finned legs 86 of the twist lock 80 can be inserted downwardly into the channel 204 through the open top thereof, as shown in FIG. 16B. A tip-to-tip measure of the two intermediate fins 88B, taken perpendicularly of the fin width W_{F} Is greater than the distance between the two inside lips 210A, 210B of the channel 204. When the lower fins 88C bottom out against the bottom wall 206 of the channel 204, denoting a fully inserted state of the twist lock 80 inside the channel 204, the installer manually holding the pipe support 10′ by the main body 12′ thereof then rotates the pipe support 10′ ninety degrees in a predetermined locking direction (clockwise, as viewed from above, in the illustrated and preferred example) in order to rotate the fins 88A-88C into orientations pointing perpendicularly cross-wise to the longitudinally oriented channel 204 of the support block assembly 200, thereby accomplishing the installed position and orientation of the pipe support 10′ shown in FIG. 16C. As revealed in the cross-section of FIG. 16D, this ninety degree rotation of the pipe support 10′ rotates the top fins 88A into frictional engagement with the inside of the two inside lips 210A, 210B of the channel 204, and rotates the intermediate fins 88B into underhooking relationship to the tips of those same two inside lips 210A, 210B of the channel 204, thereby locking the pipe support 10′ to the support block assembly 200.

During the ninety degree rotation of the pipe support 10′, the two tapered end regions 90 are the first areas of the intermediate fins 88B to engage under the tips of the inside lips 210A, 210B of the channel 204, initially at the thinnest extremities of these fins, whereupon continued rotation of the pipe support 10′ will force gradually thicker subregions of the tapered regions of the fins 88B under the inside lips 210A, 210B of the channel 204. In a default unflexed state of the twist lock 80, the distance from the bottommost extremities of the two finned legs 86 to the topsides of the thickest parts of the intermediate fins 88B exceeds the distance from the bottom wall 206 of the channel 204 to the downwardly pointing tips of the two inside lips 210A, 210B of the channel 204 (which distance may be referred to as the “internal lip height” of the channel, for brevity). In contrast, in the same unflexed state of the twist lock 80, the distance from the bottommost extremities of the two finned legs 86 to the topsides of the thinnest parts of the intermediate fins 88B (at the thinned extremities of the tapered regions thereof) does not exceed the internal lip height of the channel. Given this relative geometry of the twist lock 80 and the channel 204, rotation of the twist lock's intermediate fins 88B under the inside lips 210A, 210B of the channel 204 acts to gradually wedge increasingly thicker areas of the intermediate fins 88B beneath the inside lips 210A, 210B of the channel. This flexes the intermediate fins 88B downwardly and wedging them into increasingly tighter frictional engagement with the inside lips 210A, 210B of the channel 204, until the thickest parts of the intermediate fins 88B have been wedged beneath the inside lips of the channel, whereafter the fully installed orientation of the pipe support 10′ is achieved. While these fins 88B that hook under the lips 210A, 210B of the channel 204 are the middle (intermediate) pair among three total pairs of fins in the illustrated example, other embodiments could optionally omit one or both of the other two pairs of fins 88A, 88C, and still achieve similarly hooked engagement of the pipe support 10′ to the support block assembly 200 using a finned flexible twist lock 80. Given this, the intermediate fins 88B may alternatively be referred to herein as hooking fins, named as such for their functional purpose, rather than their relative location to optionally accompanying upper and lower fins 88A, 88C above and below these hooking fins 88B.

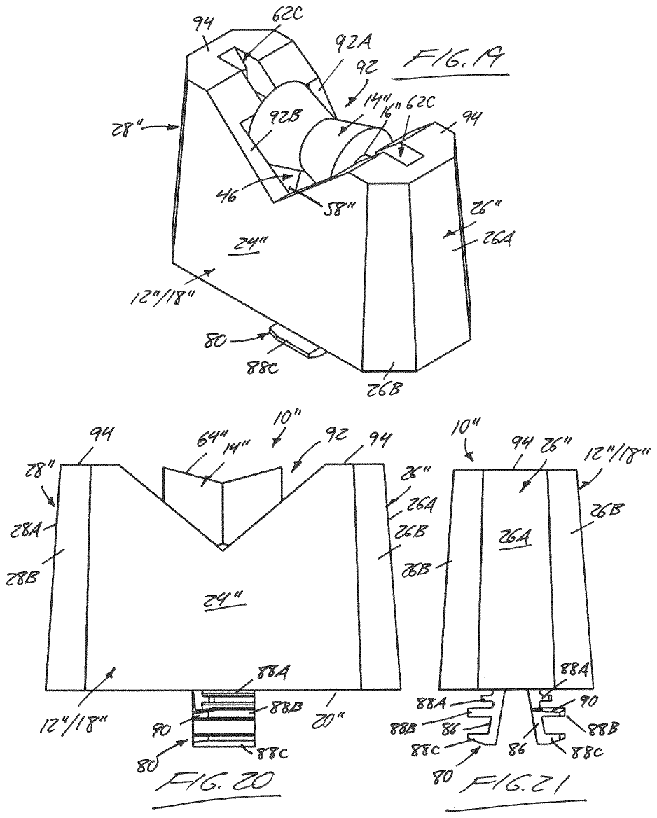

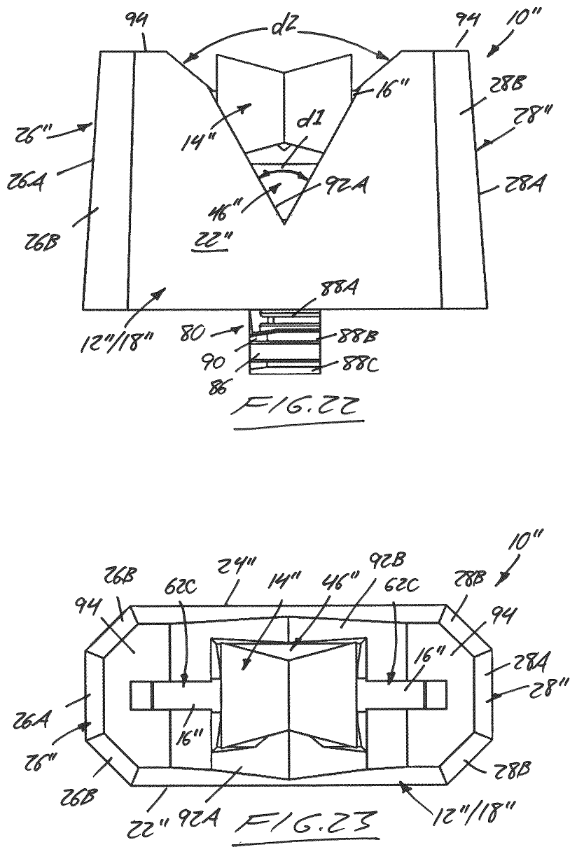

FIGS. 18 to 23 show a third embodiment of the roller-equipped pipe support 10″ that differs from the preceding two embodiments primarily in its lack of upstanding pliable arms in its main body 12″. The main body 12″ in this embodiment is analogous to the base 18, 18′ of the preceding embodiments, and therefore may be equivalently referred to as a base 18″, in that it serves at least one equivalent purpose of those of the preceding embodiments, namely as a support basis for the roller 14. In the illustrated example, the main body 12″ also differs in some geometric characteristics from the bases of the preceding embodiments. In the illustrated example, the front and rear faces 22″, 24″ are once again flat faces, but are not parallel to one another in respective vertical planes, and are instead sloped at small oblique angles tilted slightly inward from such vertical planes, and are therefore upwardly convergent with one another. Likewise, the left and right outer sides 26″, 28″ in this embodiment are also sloped at small oblique angles tilted slightly inward from the vertical planes occupied by the parallel outer sides of the bases of the preceding embodiments, and are therefore also upwardly convergent with one another. In the illustrated example, each outer side 26″, 28″ is composed of three non-coplanar faces instead of a singular uniplanar face like the outer sides of the preceding embodiments. Each outer side 26″, 28″ in this case has a central face 26A, 28A that is penetrated by the axis of the roller shaft 16″ and is straddled by two diagonal faces 26B, 28B that obliquely and symmetrically join the central face 26A, 28A to the front and rear faces 22″, 24″ of the main body 12″. The obliquely sloped front and rear faces and likewise sloped outer sides of the main body 12″ in this embodiment impart an upwardly tapered form to the main body, by which its underside is wider than its topside for added stability, though in other variants of this embodiment, the front and rear faces may instead be vertically oriented like those of the preceding embodiments, as may be the two outer sides.

Once again, the base 18″ features a roller cavity 46″ recessed into the topside thereof, though the geometry of the topside of the base 18″ differs from those of the preceding embodiments, in this case characterized by a V-shaped valley profile 92 that is symmetrically straddled by two flat shoulders 94 where the topside of the base 18″ intersects with the outer sides 26″, 28″ thereof. The roller cavity 46″ is recessed into the topside of the base 18″ within the centered valley profile 92 thereof. Like the first embodiment, the left and right sidewalls 58″, 60″ of the roller cavity 46″ have shaft cavities 62C therein for receiving the two opposing ends of the roller shaft 16″. However, the shaft cavities 62C are elevationally deeper that those of the first embodiment, and intersect the topside of the base 18″ in this embodiment. The shaft cavities 62C are therefore of open-topped character in this embodiment, as a result of which the roller shaft 16″ can be dropped into the open-topped shaft cavities 62C from the topside of the base 18″ with the roller 14″ preassembled on the roller shaft 16 for particularly easy installation of the roller 14″, without needing to flexibly widen the roller cavity to enable shaft access to the closed-top shaft cavities of the first embodiment.

In the illustrated example, the V-shaped valley profile 92 of the topside of the base 18″ is an asymmetric one, having a deeper V-shape on the front side of the roller cavity 46″ than on the opposing rear side thereof. Among these asymmetric valley profiles, the deeper V-shape 92A at the front side of the roller cavity 46″ reaches all the way down to the bottom wall 61 of the roller cavity, whereby the front side of the roller cavity has a V-shaped opening, at the nadir of which rainwater can drain through this front opening of the roller cavity. The V-shaped valley profile 92 of the base 18″ of this embodiment is a functional substitute for the absent pliable arms of the earlier embodiment, in that a pipe can optionally be laid directly upon the base 18″ itself in a rollerless implementation of the base 18″. In such instances, the V-shaped valley profile 92 will hug the laid pipe to prevent toppling thereof off either side of the base 18″ in the event of any modest lateral movement that may occur, but of course will not positively capture the pipe to the same degree as the preceding embodiments of the pipe support with the pliable arms that form a substantially enclosed pipe cavity 66, 66′ that hugs overtop of the pipe.

To equally support the pipe on both the front and rear side of the roller cavity 46″ in such rollerless implementations of the base 18″, the deeper V-shape 92A at the front side of the roller cavity 46″ has a first angle of divergence d1 over a lower majority thereof, and then a wider second angle of divergence d2 at an upper minority thereof, which wider second angle of divergence d2 is shared by the shallower V-shape 92B at the rear side of the roller cavity 46″. The more divergent upper fraction of the deeper V-shape 92A in front of the roller cavity 46″ is equivalently angled to, and aligns with, the equivalent upper fraction of the shallower V-shape 92B behind the roller cavity 46″. A pipe laid directly atop the base 18″ in a rollerless implementation therefore rests on the divergent sides of the shallower V-shape 92B behind the roller cavity 46″ and on the equivalently angled divergent sides of the more divergent upper minority of the deeper V-shape 92A in front of the roller cavity, whereby the load of the pipe is carried in balanced and level fashion in front of and behind the roller cavity. When the roller assembly (preassembled roller 14″ and roller shaft 16″) is installed in the base 18″, the uppermost peripheral region 64 of the roller 64″ resides above both the deeper and shallower V-shapes 92A, 92B of the V-shaped valley profile 92 to carry the pipe in elevated fashion above the V-shaped profile 92 of the base 18″, for example near a plane of the two upper shoulders 94 of the base.

As shown, the base 18″ may optionally have a twist lock 80 of the same type described of the preceding embodiment installed in the underside 20″ of the base 18″ to enable optional mounting of the pipe support 10″ to a support block assembly 200 in the same manner as described of the preceding embodiment and illustrated in FIGS. 16A-16D. Just like the preceding embodiment, the underside 20″ of the base 18″ may instead be seated directly on a rooftop or other surface in absence of the selectively attachable (e.g. plug-in) twist lock 80.

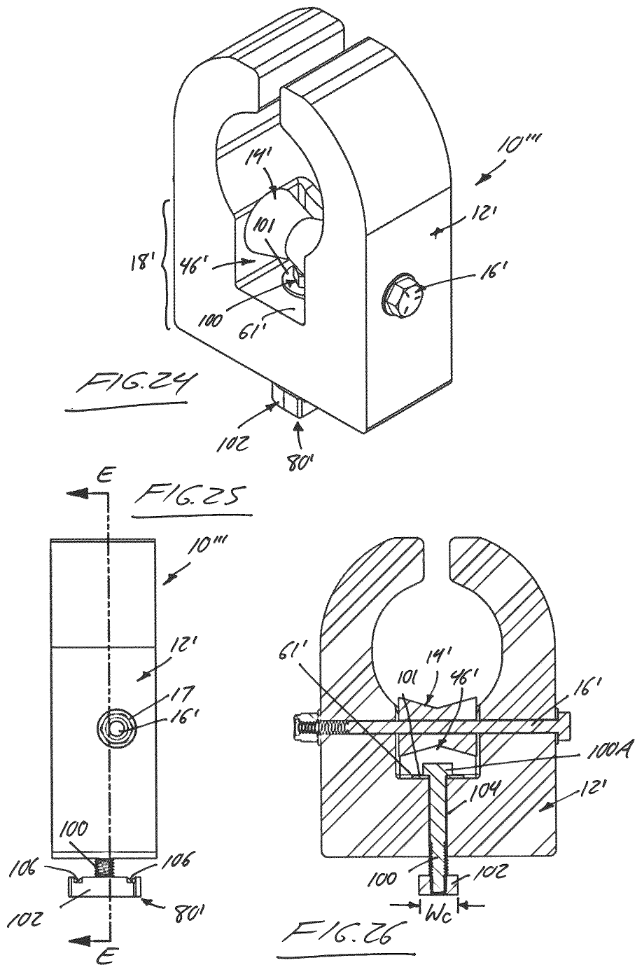

FIGS. 24 to 26 illustrate a variant of the second embodiment roller-equipped pipe support 10′″, which differs only in the details of its twist lock 80′, which in this embodiment is not a single-piece flexible polymeric twist lock 80, but is instead a multi-piece mechanical twist lock 80′ composed of a threaded bolt 100 and a mating clamp 102. The threaded bolt 100 is fed from the roller cavity 46′, before installation of the roller assembly therein, through a lock bore 104 that penetrates the bottom wall 61′ of the shaft cavity 46′, from which the bolt passes through to the underside 20′ of the base 18′. Installation of the bolt 100 is preferably accompanied by a washer 101 installed between the head 100A of the Bolt 100 and the bottom wall 61 of the roller cavity 46′. The lock bore 104 may optionally be included in the first embodiment for equivalent purpose, as illustrated in the earlier figures thereof.

The clamp 102 is threaded onto the shaft of the bolt 100 below the underside 20′ of the base 18′, for the purpose of ultimately engaging the inside lips 210A, 210B of the channel 204 of the support block assembly 200 in an installed state of the pipe support 10′″ thereon. The clamp 102 is a metal block or fitting with a threaded hole therein by which it is rotatably mated to the bolt 100. The clamp 102 is longer than it is wide in directions measured horizontally perpendicular (radially) of the vertical bolt 100, and the width of the clamp W_{C} is slightly less than the distance between the two inside lips 210A, 210B of the channel 204, while the length of the clamp is greater than said distance. As described of the earlier flexible twist lock 80, the result is that the clamp 102 can be inserted into the channel 204 in one orientation in which its narrow width fits through the open top of the channel 204 between the inside lips 210A, 210B thereof, and then turned 90-degrees into an orientation hooking beneath the two inside lips 210A, 210B of the channel.

The clamp 102 has two slots 106 therein, running widthwise thereof at the topside of the clamp 102, each slot having a width suitable to accommodate mating insertion of the downwardly pointing tip of a respective one of the channel's two inside lips 210A, 210B. Accordingly, after insertion of the clamp 102 into the channel 204, and turning of the clamp 102 ninety degrees to place the slotted areas of the clamp 102 respectively beneath the two inside lips 210A, 210B of the channel 204, the main body 12′ of the pipe support 10′″ is manually lifted upward by the installer. Via the bolt 100, such manual lifting of the main body 12′ also lifts the clamp 102 therewith, thus engaging the downwardly pointing tips of two inside lips 210A, 210B of the channel 204 into the two slots 106 in the topside of the clamp 102. This engagement of the inside lips 210A, 210B of the channel 204 into the slots 106 of the clamp 102 mechanically blocks relative rotation between the clamp 102 and the channel 204, whereupon the installer can tighten the bolt 100 from inside the roller cavity 46′. This tightening of the bolt 100 serves to draw the clamp 102 and the main body 12′ of the pipe support 10′″ together, the ultimate result of which is to eventually abut the underside 20′ of the main body 12′ firmly against the top of the channel 204, with the clamp 102 held fast in its slotted engagement with the inside lips of the channel 204, thereby locking the pipe support 10′″ in place on the support block assembly 200. Just like this variant of the second embodiment, the third embodiment pipe support 10′″ may also be modified to have a lock bore 104 therein that penetrates the bottom wall 61 of the roller cavity 46′″ and the underside of the base 18′″ for such installation of a bolt-tightened mechanical twist lock, instead of having receiving sockets and a host cavity 86 in the underside of the base 18″ for selective receipt of a plug-in flexible twist lock 80.

Since various modifications can be made in the invention as herein above described, and many apparently widely different embodiments of same made, it is intended that all matter contained in the accompanying specification shall be interpreted as illustrative only and not in a limiting sense.

1. A pipe support comprising:
a block of elastomeric material comprising an underside, a topside of opposing relationship to the underside in a height direction, a front side, a rear side of opposing relationship to the front side in an axial direction, a left side, and a right side of opposing relationship to the left side in a lateral direction;
a roller cavity defined in said block and that is open at the topside thereof and is bound by the elastomeric material of the block at least at left and right sides of the roller cavity that reside opposite of one another in the lateral direction; and
a roller rotatably supported on the block of elastomeric body in a position borne partially within the roller cavity thereof and rotatable about a laterally oriented rotation axis, and with an upper peripheral region of the roller elevated above the topside of the block for rested support of a pipe atop the upper peripheral region of the roller in a position lying axially of the block and transversely the rotation axis.

2. The pipe support of claim 1 wherein the block is part of a unitary body of said elastomeric material that further comprises first and second pliable arms integrally joined to said block and upstanding therefrom at positions spaced apart from one another in a lateral direction to form a pipe cavity between said first and second pliable arms in which the pipe can be laid axially across said block and laterally constrained between said pliable arms, which pliable arms terminate at terminal ends of non-attached relation to one another at an elevation above the block, at which terminal ends said pliable arms are spreadable apart, via resilient flexure of the pliable arms relative to the block, to increase a gap space between said terminal ends to permit admission of the pipe into said pipe cavity through said gap space.

3. The pipe support of claim 1 wherein said roller cavity comprises left and right cavity sidewalls at the left and right sides of the roller cavity, at least one of which has a respective shaft cavity recessed therein, and the pipe support further comprises a roller shaft on which the roller is supported, and a respective end of which is received in said respective shaft cavity to support said roller shaft in a position spanning laterally across the roller cavity.

4. The pipe support of claim 3 wherein the left and right cavity sidewalls each have respective left and right shaft cavities recessed therein, and opposing left and right ends of the roller shaft are respectively received in said left and right shaft cavities.

5. The pipe support of claim 1 wherein said roller cavity comprises left and right cavity sidewalls at the left and right sides of the roller cavity, at least one of which is intersected by a respective shaft bore that penetrates into the roller cavity from a respective one of the left or right side of the block, and the pipe support further comprises a roller shaft that passes through the shaft bore to rotatably support the roller in the roller cavity.

6. The pipe support of claim 5 wherein the left and right cavity sidewalls are respectively intersected by left and right shaft bores that penetrate into the roller cavity from the left and right sides of the block, respectively, and the roller shaft passes through both the left and right shaft bores.

7. The pipe support of claim 3 wherein the roller shaft is borne directly by elastomeric material of the block.

8. The pipe support of claim 1 wherein the roller cavity is bound by the elastomeric material of the block at least at one of axially opposing front and rear sides of the roller cavity.

9. The pipe support of claim 8 wherein the roller cavity is bound by the elastomeric material of the block at both the front and rear sides of the roller cavity.

10. The pipe support of claim 8 wherein the roller cavity is bound by the elastomeric material of the block at said one of the front and rear sides of the roller cavity, and is at least partially open at the other of said front and rear sides of the roller cavity.

11. The pipe support of claim 1 wherein the base comprises at least one drain opening communicating the roller cavity with an exterior of the unitary body to facilitate drainage from said roller cavity.

12. A method of producing roller-equipped and rollerless pipe supports, comprising producing or otherwise obtaining a plurality of elastomeric blocks having respective roller cavities therein of open character at topside of the elastomeric blocks, and installing rollers in the respective roller cavities of only a subset of said elastomeric blocks, for use of said subset of said elastomeric blocks in applications where axial pipe expansion and contraction is anticipated, and leaving another subset of said elastomeric blocks rollerless, for use of said another subset of the elastomeric blocks in applications where lesser, or no, axial pipe expansion and contraction is anticipated.

13. The method of claim 12 wherein installing at least one of said rollers in the respective roller cavity of a respective one of the subset of said elastomeric blocks comprises inserting one end of a roller shaft of said roller into a respective shaft cavity in one of two laterally opposing sidewalls of the roller cavity.

14. The method of claim 13 wherein said installation of said at least one of said rollers in the respective roller cavity of the respective one of the subset of said elastomeric blocks comprises inserting a second end of said roller shaft into a second respective shaft cavity in a second of said two laterally opposing sidewalls of the roller cavity.

15. The method of claim 12 wherein installing at least one of said rollers in the respective roller cavity of a respective one of the subset of said elastomeric blocks comprises inserting a roller shaft of said roller into the roller cavity via a respective shaft bore that penetrates an exterior side of the elastomeric block and a respective side of the roller cavity.

16. The method of claim 15 wherein said installing of said at least one of said rollers in the respective roller cavity of said respective one of the subset of said elastomeric blocks comprises passing one end said roller shaft full through the roller cavity and the elastomeric block to a second exterior side of the elastomeric block via second shaft bore that penetrates said second exterior side of the elastomeric block and a respective second side of the roller cavity.

17. The method of claim 15 wherein said installing of said at least one of said rollers in the respective roller cavity of said respective one of the subset of said elastomeric blocks comprises inserting the roller separately of the roller shaft through an open side of the roller cavity, and then inserting the roller shaft into the roller cavity and said roller.

18. The method of claim 12 wherein at least one of the elastomeric blocks is a base of a pipe support that further comprises first and second pliable arms integrally joined to said block and upstanding therefrom at positions spaced apart from one another in a lateral direction to form a pipe cavity between said first and second pliable arms in which the pipe can be laid axially across said block and laterally constrained between said pliable arms, which pliable arms terminate at terminal ends of non-attached relation to one another at an elevation above the block, at which terminal ends said pliable arms are spreadable apart, via resilient flexure of the pliable arms relative to the block, to increase a gap space between said terminal ends to permit admission of the pipe into said pipe cavity through said gap space.

19. The method of claim 18 wherein at least one of said elastomeric blocks is an armless block lacking said first and second pliable arms.

20. A pipe support comprising:
a unitary body of elastomeric composition comprising:
a base; and
first and second pliable arms integrally joined to said base and upstanding therefrom at positions spaced apart from one another in a lateral direction to form a pipe cavity between said first and second pliable arms in which a pipe can be laid across said base, in an axial direction transverse to said lateral direction, and laterally constrained between said pliable arms, which pliable arms terminate in respective terminal ends of non-attached relation to one another, at which terminal ends said pliable arms are spreadable apart, via resilient flexure of the pliable arms relative to the base, to increase a gap space between said terminal ends to permit admission of the pipe into said pipe cavity through said gap space; and
a roller cavity defined in said base of the unitary body in a position of open communication with said pipe cavity at a bottom thereof.
